(19) United States
(12) Patent Application Publication
(10) Pub. No.: US 2022/0318859 A1
(43) Pub. Date: Oct. 6, 2022

(54) DETECTION, CHARACTERIZATION, AND PRESENTATION OF CHARGING STATIONS FOR ELECTRIC VEHICLES

(71) Applicant: GM GLOBAL TECHNOLOGY OPERATIONS LLC, DETROIT, MI (US)

(72) Inventors: Ariel Telpaz, Givat Haim Meuhad (IL); Barak Hershkovitz, Herzliya (IL); Nadav Baron, Herzliya (IL); Ravid Erez, Hod-Hasharon (IL); Boris Kabisher, Yokneam (IL); Omer Zerbib, Kfar Saba (IL)

(21) Appl. No.: 17/215,576

(22) Filed: Mar. 29, 2021

(51) Int. Cl. G06Q 30/02; G06N 5/02

(52) U.S. Cl. CPC G06Q 30/0281; G06N 5/02

(57) ABSTRACT

A system includes a memory device, and one or more processors for detection, characterization, and presentation of charging stations for electric vehicles. The processors determine that a charging station is an undocumented charging station; a documented charging station is one that is part of a dataset of known charging stations. A confidence score is computed to indicate whether the charging station is a public charging station. In response to the confidence score being greater than a first predetermined threshold, the undocumented charging station is documented as a public charging station. In response to the confidence score being lesser than the first predetermined threshold and greater than a second predetermined threshold, the undocumented charging station is added to a list of charging stations to investigate. In response to the confidence score being lesser than the second predetermined threshold, the undocumented charging station is documented as a private charging station.

### INTRODUCTION

The present disclosure relates to systems, storage media, and methods for detecting, characterizing, and presenting charging stations for electric vehicles based on users' charging patterns.

Various types of automotive vehicles, such as electric vehicles (EVs), extended-range electric vehicles (EREVs), and hybrid electric vehicles (HEVs), are equipped with energy storage systems that require periodic charging. An energy storage system may be charged by connecting to a power source, such as an AC supply line. It should be noted that any automotive vehicle that is charged using an AC supply line is referred to as an “electric vehicle” herein.

### SUMMARY

According to one or more embodiments, a system includes a memory device and one or more hardware processors configured by machine-readable instructions for detection, characterization, and presentation of charging stations for electric vehicles. The one or more hardware processors are configured to determine that a charging station used during a charging session is an undocumented charging station. A documented charging station is part of a dataset of known charging stations. The one or more hardware processors are further configured to determine using a prediction model, a confidence score that the charging station is a public charging station. The prediction model uses one or more attributes associated with the charging station to determine the confidence score. The one or more hardware processors are further configured to add the undocumented charging station to the dataset of known charging stations as a public charging station in response to the confidence score being greater than a first predetermined threshold. The one or more hardware processors are further configured to add the undocumented charging station to a list of charging stations to investigate, in response to the confidence score being lesser than the first predetermined threshold and greater than a second predetermined threshold. The one or more hardware processors are further configured to add the undocumented charging station to the dataset of known charging stations as a private charging station in response to the confidence score being lesser than the second predetermined threshold.

In one or more embodiments, the one or more hardware processors are further configured to, in response to a request from a first electric vehicle, identify one or more public charging stations in a specific geographic region using the dataset of known charging stations.

In one or more embodiments, the geographic region corresponds to the first electric vehicle's planned route. In one or more embodiments, the charging station was used by the first electric vehicle or by a second electric vehicle.

In one or more embodiments, the one or more hardware processors are further configured to train the prediction model using the one or more attributes associated with a second charging station in response to the second charging station being used during the charging session and the second charging station being a documented charging station.

In one or more embodiments, the one or more hardware processors are further configured to determine that the charging station used during the charging session is on the list of charging stations to investigate. Further, the hardware processors determine, using the prediction model, the confidence score that the charging station is a public charging station using a different set of attributes associated with the charging station.

In one or more embodiments, the one or more hardware processors are further configured to associate the charging station as part of a cluster of charging stations using a clustering algorithm, wherein the clustering is performed based on geographic attributes of the charging station.

According to one or more embodiments, a non-transient computer-readable storage medium includes instructions being executable by one or more processors to perform a method for detection, characterization, and presentation of charging stations for electric vehicles. The method includes determining, by a processor, that a charging station used during a charging session is an undocumented charging station, wherein a documented charging station being one that is part of a dataset of known charging stations. The method further includes determining, by the processor, using a prediction model, a confidence score that the charging station is a public charging station, wherein the prediction model using one or more attributes associated with the charging station to determine the confidence score. The method further includes, in response to the confidence score being greater than a first predetermined threshold, adding, by the processor, the undocumented charging station to the dataset of known charging stations as a public charging station. The method further includes, in response to the confidence score being lesser than the first predetermined threshold and greater than a second predetermined threshold, adding, by the processor, the undocumented charging station to a list of charging stations to investigate. The method further includes, in response to the confidence score being lesser than the second predetermined threshold, adding, by the processor, the undocumented charging station to the dataset of known charging stations as a private charging station.

In one or more embodiments, the method further includes in response to a request from a first electric vehicle, identifying, by the processor, one or more public charging stations in a specific geographic region using the dataset of known charging stations. In one or more embodiments, the geographic region corresponds to a planned route of the first electric vehicle.

In one or more embodiments, the charging station was used by the first electric vehicle or by a second electric vehicle.

In one or more embodiments, the prediction model using the one or more attributes is associated with a second charging station in response to the second charging station being used during the charging session, and the second charging station being a documented charging station.

In one or more embodiments, the method further includes determining, by the processor, that the charging station used during the charging session is on the list of charging stations to investigate. Further, in response, the processor determines, using the prediction model, the confidence score that the charging station is a public charging station using a different set of attributes associated with the charging station.

In one or more embodiments, the method further includes associating, by the processor, the charging station as part of a cluster of charging stations using a clustering algorithm, wherein the clustering is performed based on geographic attributes of the charging station.

According to one or more embodiments, a computer-implemented method for detection, characterization, and presentation of charging stations for electric vehicles includes determining, by a processor, that a charging station used during a charging session is an undocumented charging station, wherein a documented charging station being one that is part of a dataset of known charging stations. The method further includes determining, by the processor, using a prediction model, a confidence score that the charging station is a public charging station, wherein the prediction model using one or more attributes associated with the charging station to determine the confidence score. The method further includes, in response to the confidence score being greater than a first predetermined threshold, adding, by the processor, the undocumented charging station to the dataset of known charging stations as a public charging station. The method further includes, in response to the confidence score being lesser than the first predetermined threshold and greater than a second predetermined threshold, adding, by the processor, the undocumented charging station to a list of charging stations to investigate. The method further includes, in response to the confidence score being lesser than the second predetermined threshold, adding, by the processor, the undocumented charging station to the dataset of known charging stations as a private charging station.

In one or more embodiments, the method further includes, in response to a request from a first electric vehicle, identifying, by the processor, one or more public charging stations in a specific geographic region using the dataset of known charging stations. The geographic region corresponds to a planned route of the first electric vehicle. In one or more embodiments, the charging station was used by the first electric vehicle or by a second electric vehicle.

In one or more embodiments, the method further includes training, by the processor, the prediction model using the one or more attributes associated with a second charging station in response to the second charging station being used during the charging session, and the second charging station being a documented charging station.

In one or more embodiments, the method further includes determining, by the processor, that the charging station used during the charging session is on the list of charging stations to investigate. Further, the method includes, in response, determining, by the processor, using the prediction model, the confidence score that the charging station is a public charging station using a different set of attributes associated with the charging station.

The above features and advantages, and other features and advantages of the disclosure are readily apparent from the following detailed description when taken in connection with the accompanying drawings.

### BRIEF DESCRIPTION OF THE DRAWINGS

Other features, advantages, and details appear, by way of example only, in the following detailed description, the detailed description referring to the drawings.

FIG. 1 illustrates a system configured for detection, characterization, and presenting charging stations to a user of an electric vehicle;

FIG. 2 illustrates an example flow diagram of a method, according to one or more embodiments;

FIG. 3 depicts a method according to one or more embodiments;

FIG. 4 depicts an example scenario of a cluster of charging stations detected according to one or more embodiments;

FIG. 5 depicts an operational flow of a method for detection, characterization, and presentation of charging stations for electric vehicles according to one or more embodiments;

FIG. 6 depicts an operational flow depicting a method for presentation of charging stations for electric vehicles according to one or more embodiments; and

FIG. 7 depicts a computer system in accordance with an embodiment.

### DETAILED DESCRIPTION

The following description is merely exemplary in nature and is not intended to limit the present disclosure, its application, or its uses. It should be understood that throughout the drawings, corresponding reference numerals indicate like or corresponding parts and features. As used herein, the term module refers to processing circuitry that may include an application-specific integrated circuit (ASIC), an electronic circuit, a processor (shared, dedicated, or group) and memory that executes one or more software or firmware programs, a combinational logic circuit, and/or other suitable components that provide the described functionality.

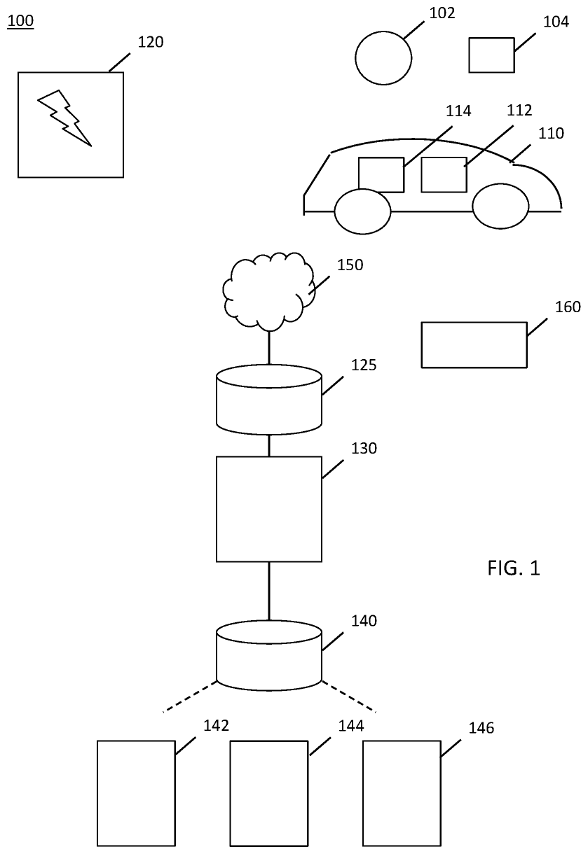

FIG. 1 illustrates a system 100 configured for detection, characterization, and presenting charging stations to a user of an electric vehicle. A user 102 of an electric vehicle 110 (“vehicle”) is presented information of one or more charging stations 120.

The charging stations' information is presented to the user 102 via a communication device 104 in one or more embodiments. The communication device 104 can be a phone, a tablet computer, a laptop computer, a desktop computer, or any other communication device. The communication device 104 can include one or more processing units such as microprocessors and other such processing units that can execute one or more computer-executable instructions. The communication device 104 can also include one or more memory devices that store such computer-executable instructions and/or other data used to execute the computer-executable instructions.

In one or more embodiments, the information is presented to user 102 via an infotainment system 112 of the vehicle 110. The infotainment system 112 can include one or more processing units such as engine control units (ECUs), microprocessors, and other such processing units that can execute one or more computer-executable instructions. The infotainment system 112 can also include one or more memory devices that store such computer-executable instructions and/or other data used to execute the computer-executable instructions.

In one or more embodiments, the infotainment system 112 can access one or more sensors 114. The infotainment system 112 can access data from the sensors 114, for example, using the respective sensors' application programming interface 114. The sensors 114 can include a location sensor, for example, a global positioning system (GPS) that provides information about the geographic location of the vehicle 110. The sensors 114 can include a battery sensor that detects the amount of charge in a battery of the vehicle 110. The sensors 114 can include a charging station sensor that identifies one or more attributes of the charging station 120 that is used to charge the vehicle 110.

Attributes of the charging station 120 can include a unique station-identifier, charging speed (charging level), wattage, session fees, time fees, per kilowatt-hour fees, penalties for staying over the time limit, and other such attributes.

When the user 102 uses the charging station 120 to recharge the vehicle 110, the infotainment system 112 records a charging session in a dataset 125. The charging session dataset 125 is stored at a location that is remote from the vehicle 110. It is understood that the infotainment system 112 can maintain a local copy of the charging session data that is recorded in the charging session dataset 125. Further, it should be noted that the infotainment system 112 can record the charging session data in the charging session dataset 125 during the recharging or later. The infotainment system 112 accesses the charging session dataset 125 via a communication network 150, such as a WIFI® network, a cellular network, or any other type of communication network or a combination thereof.

The charging session dataset 125 is a database that stores multiple charging session data entries. While FIG. 1 depicts the charging session dataset 125 receiving data from a single vehicle 110, in some embodiments, the charging session dataset 125 receives charging session data entries from several vehicles 110.

Table 1 depicts a charging session dataset according to one or more embodiments. Each entry in the charging session dataset 125 represents a charging session. Each entry includes identifying information associated with the charging session, such as a unique identifier of the charging session, a unique identifier of the charging station 120, a unique identifier of the vehicle 110, a unique identifier of the user 102 initiating the charging, etc. In addition, each entry includes several attributes associated with the charging session, such as the one or more attributes of the charging station 120, time-of-day when the charging was performed, location at which the charging was performed, the geographical context of the charging station 120, etc. It is understood that the number of attributes and number of entries shown in Table 1 are illustrative and that in embodiments of the technical solutions described herein, those numbers can vary.

TABLE 1

| | | | | | | |
|---|---|---|---|---|---|---|
| Session Id | Vehicle ID | Station ID | User ID | Attribute 1 | Attribute 2 | . . . |

[symbol]

[symbol]

indicates data missing or illegible when filed

When presenting the user 102 of the vehicle 110 with available charging stations 120 along a planned route, the existing systems determine charging stations based on databases that are updated periodically by third parties. However, as different vendors install new charging stations, these databases may be outdated and not include charging stations that might be, in reality, available to the user 102. In some cases, knowledge of the “missing” charging stations from the database can improve route planning, for example, improving time-saving and reducing range-anxiety. Embodiments described herein address such technical challenges by collecting and analyzing the charging session dataset 125 to detect charging stations that are not apparent in existing databases. In one or more embodiments, such analysis is performed by employing machine learning techniques.

Technical challenges with existing systems further include that the available data is dependent on manual updates to the database. Further, the charging station data in existing databases is typically provided by third parties, such as the charging stations' providers, and can be inaccurate. In some cases, the charging station data is not readily accessible because such data is hosted by third parties, and the access is dependent on the third parties' database, accessibility, etc. Embodiments described herein address such technical challenges by facilitating the charging session dataset 125 to be automatically updated when one or more vehicles 110 use one or more charging stations. According to one or more embodiments, such charging session data is analyzed to characterize charging stations based on usage patterns and other attribute data from the charging session dataset 125. Further, the charging station data and the learned characteristics are presented to the user 102 (or any other user) via the device 104 and/or the infotainment system 112. Embodiments described herein enhance documentation of charging stations that already exist in the databases and help document any undocumented charging stations.

Further, embodiments described herein facilitate automatic identification of public charging stations based on the charging session data. Existing databases and/or charging station attributes do not provide such information explicitly. A “public” charging station is a charging station that can be used by any user 102 and is at a public location such as a mall, a shopping center, a rest area, a parking area, or any other publicly accessible location. Further yet, embodiments described herein further facilitate characterization of the charging stations 120, such as based on average charging time and other attributes to facilitate planning an optimized charge plan for the user 102. Additionally, inaccurate data regarding documented stations is updated in one or more embodiments by the computing device 130. For example, a documented charging station that is not listed as a “fast charger,” but analyzing the data from the charging session dataset 125 indicates that it is, in fact, fast.

Referring to FIG. 1 again, the charging session dataset 125 is accessible by a computing device 130. The computing device 130 can be a server computer, a laptop computer, a tablet computer, a desktop computer, or any other such device that includes one or more processing units coupled with one or more memory devices. The processing units execute one or more computer-executable instructions that are stored on the memory devices. In one or more embodiments, the processing units execute the computer-executable instructions to implement one or more methods described herein.

The computing device 130 analyzes the charging session dataset 125. The computing device 130, based on the analysis, updates a charging station dataset 140.

Table 2 depicts a charging station dataset according to one or more embodiments. The charging station dataset 140 includes multiple entries, each entry representing a respective charging station (such as the charging station 120). Each entry includes identification information associated with the charging station 120, such as the unique identifier of the charging station 120. In addition, each entry includes several attributes associated with the charging station. The attributes can include a provider name/identification, charging price schedule, charging speed, charging location (GPS coordinates), charging level, etc.

TABLE 2

| | | | | | | |
|---|---|---|---|---|---|---|
| Station ID | Attribute 1 | Attribute 2 | Attribute 3 | . . . | Public/Private | Cluster ID |

[symbol]

[symbol]

indicates data missing or illegible when filed

In addition, the attributes include the geographical context of the charging station 120. For example, Table 3 includes a list of attributes that can be captured for the geographical context of the charging station 120. It is understood that the list of attributes from Table 3 is exemplary and that other attributes (i.e., additional/different attributes) can be used in other embodiments.

TABLE 3

Count “nearBy_bench”
Count “nearBy_bicycle_parking”
Count “nearBy_cafe”
Count “nearBy_charging_station”
Count “nearBy_fast_food”
Count “nearBy_fuel”
Count “nearBy_hospital”
Count “nearBy_parking”
Count “nearBy_parking_entrance”
Count “nearBy_parking_space”
Count “nearBy_place_of_worship”
Count “nearBy_restaurant”
Count “nearBy_school”
Count “nearBy_ townhall”
“landuse_cemetery”
“landuse_commercial”
“landuse_construction”
“landuse_farmland”
“landuse_flowerbed”
“landuse_forest”
“landuse_grass”
“landuse_industrial”
“landuse_meadow”
“landuse_recreation_ground”
“landuse_residential”
“landuse_retail”

Based on the charging session dataset 125, which includes entries for the charging station 120, the computer device 130 determines if the charging station 120 is part of a cluster of charging stations. The computer device 130 revises the charging station dataset 140 to include the identification of such a cluster (e.g., cluster ID) upon the determination. Further, the computer device 130 also determines whether the charging station 120 is a public charging station or a private charging station based on the charging session dataset 125. The computer device 130 accordingly updates the corresponding entry in the charging station dataset 140 to indicate such a finding (e.g., public/private). It should be noted that the charging session dataset 125 includes entries corresponding to one or more charging sessions for the charging station 120. Each charging session data can be from different vehicles.

As depicted in FIG. 1, the computer device 130 can facilitate maintaining three separate lists of charging stations in the charging station dataset 140. A first list 142 includes documented charging stations, which are known public charging stations; a second list 144 includes documented charging stations, which are known private charging stations; and a third list 146 includes a list of charging stations to investigate (i.e., not known if public/private). It should be noted that although the lists 142, 144, 146 are depicted as separate boxes in FIG. 1, in some embodiments, the lists can be maintained as part of a single dataset (e.g., charging station dataset 140) with at least one attribute (e.g., public/private) indicative of the determination. In other embodiments, the three lists 142, 144, 146 can be separately maintained.

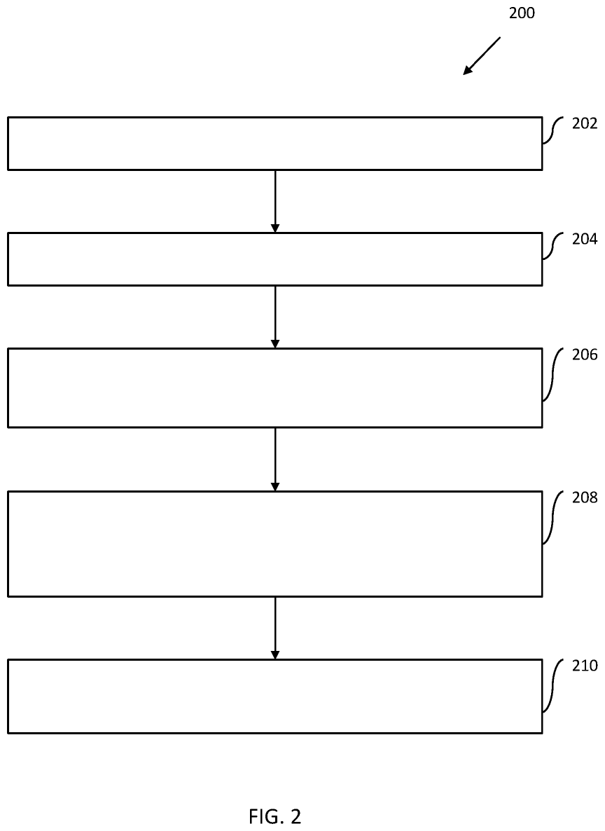

FIG. 2 illustrates an example flow diagram of a method 200, according to one or more embodiments. The method 200 may include determining, by the computer device 130, that the charging station 120 used during a charging session by the vehicle 110 is an undocumented charging station at block 202. A “documented charging station” is part of the charging station dataset 140 of known charging stations. In one or more embodiments, if the unique identifier of the charging station 120 is not present in the charging station dataset 140, the charging station 120 can be deemed an undocumented charging station.

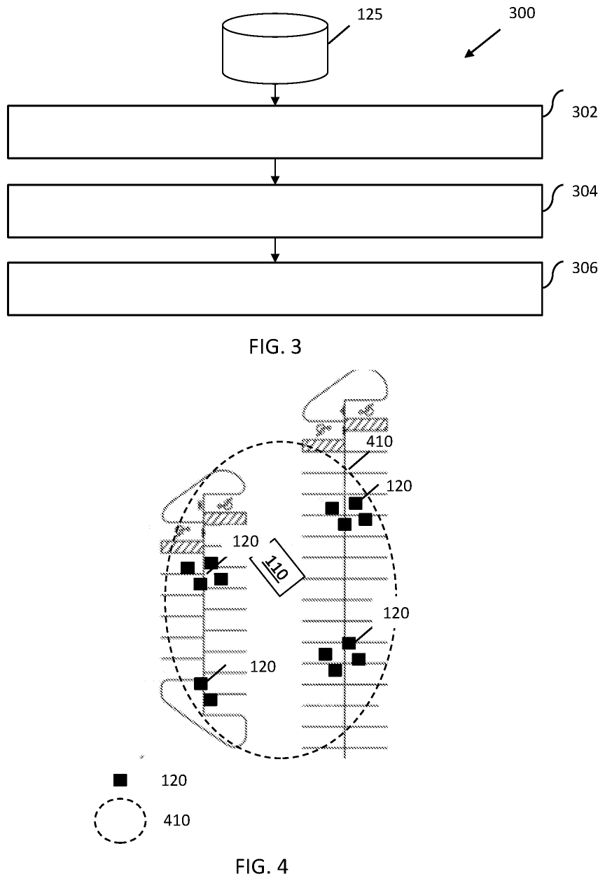

Alternatively, or in addition, determining whether the charging station is unmatched includes performing a clustering for the charging station 120. FIG. 3 depicts a method 300 according to one or more embodiments. The method 300 includes accessing the charging session dataset 125 and performing a clustering algorithm to determine one or more clusters of the charging stations 120 that are included in the charging session dataset 125, at block 302. The clustering algorithm can be a known algorithm such as density-based spatial clustering of applications with noise (DBSCAN) or any other such algorithm. The type of clustering algorithm used does not affect aspects of the technical solutions provided by embodiments herein.

FIG. 4 depicts an example scenario of a cluster of charging stations detected according to one or more embodiments. The clustering algorithm uses one or more spatial attributes of the charging stations 120 to determine which charging stations 120 form a cluster 410. The spatial attributes include geographical location to determine which charging stations 120 belong to the same cluster 410.

Referring to FIG. 3 again, the method 300 includes determining a profile for each cluster, at block 304. For example, as shown in Table 4, the computer device 130 accumulates various characteristics for the cluster 410.

The characteristics can include unique identifiers of vehicles that have been charged at the charging stations in the cluster 410, number of fast-charging stations in the cluster 410, average charging duration at the cluster 410, average charging price at the cluster 410, etc. It should be noted that the charging stations 120 that are deemed to be in the same cluster 410 can be from different providers (e.g., power companies, charging station installation companies, etc.). The characteristics are accumulated by the computer device 130 using the data from the charging session dataset 125. In one or more embodiments, the computer device 130 also analyzes and populates characteristics such as the proportion of occupancy of the charging stations in the cluster 410 at different times of day, days of the week, and so on.

TABLE 4

| Cluster | |
|---|---|
| Characteristics | Description |
| “distinctVehicles” | Unique vehicles that charged in the cluster |
| | location |
| “vin_dispersion” | Deviation in the number of charging's per vehicle |
| “sampleSize” | How many samples form the cluster |
| “CType_Station” | Proportion of charges with “station” connection |
| “CType_Fast” | Proportion of charges with “Fast” connection |
| “CType_Unavailable” | Proportion of charges with ″Unavailable″ |
| | connection |
| “CType_cord” | Proportion of charges with “cord” connection |
| “cpwr_est_min” | Min power measured across all samples in the |
| | cluster |
| “cpwr_est_max” | Max power measured across all samples in the |
| | cluster |
| “cpwr_est_mean” | Average power measured across all samples in the |
| | cluster |
| “dur_mean” | Average charging duration |
| “dur_max” | Longest charging duration |
| “weekDay_weekend” | Proportion of charges happening on weekends |
| “weekDay_workday” | Proportion of charges taking place on workdays |
| “partDay_evening | Proportion of charges taking place during the |
| | evening |
| “partDay_night” | Proportion of charges taking place during the night |
| “partDay_afternoon” | Proportion of charges taking place during the |
| | afternoon |
| “partDay_morning” | Proportion of charges taking place during the |
| | morning |
| “Documented | is there a station near the centroid of the cluster |
| Station” | |
| Cluster Spread | The spreading of the samples within the cluster |

Further, at block 306, the computer device 130 accumulates geographical context of the cluster 410. Table 5 depicts an example of geographical context of a cluster according to one or more embodiments.

The geographical context can include geographical characteristics of the surroundings of the cluster 410, such as available amenities. For example, cafés, restaurants, restrooms, benches, and other such facilities that the user 102 can avail of while the vehicle 110 is being charged at one of the charging stations 120 in the cluster 410. The computer device 130 accumulates the geographical context of the cluster 410 by querying additional service providers (not shown) using application programming interfaces, such as “open street map,” or other such servers of third parties that provide such data.

TABLE 5

Count “nearBy_bench”
Count “nearBy_bicycle_parking”
Count “nearBy_cafe”
Count “nearBy_charging_station”
Count “nearBy_fast_food”
Count “nearBy_fuel”
Count “nearBy_hospital”
Count “nearBy_parking”
Count “nearBy_parking_entrance”
Count “nearBy_parking_space”
Count “nearBy_place_of_worship”
Count “nearBy_restaurant”
Count “nearBy_school”
Count “nearBy_ townhall”
“landuse_cemetery”
“landuse_commercial”
“landuse_construction”
“landuse_farmland”
“landuse_flowerbed”
“landuse_forest”
“landuse_grass”
“landuse_industrial”
“landuse_meadow”
“landuse_recreation_ground”
“landuse_residential”
“landuse_retail”

The third-party servers are queried using the location of the cluster 410. In one or more embodiments, a centroid of the cluster 410 is determined and used as the location for the querying. The centroid of the cluster 410 can be determined by computing a centroid of the geographical area spanned by the charging stations 120 of the cluster 410. Alternatively, the centroid is determined as the charging station 120 of the cluster that has one or more values from the characteristics greater (or lesser) than a predetermined threshold. For example, the charging station 120 that has the most occupancy from those in the cluster 410 can be deemed to be the centroid. Any other characteristic(s) can be used to determine the centroid of the cluster 410.

Referring back to the flowchart in FIG. 2, in one or more embodiments, the method 200 determines (at block 202) if a charging station 120 that is encountered when analyzing the charging session dataset 125 is an undocumented charging station if the charging station 120 is not part of any existing clusters 410. If the charging station 120 is a documented charging station (i.e., is part of a cluster 410 or has been profiled earlier) the charging station is used to train a prediction model that is used to determine whether a charging station is public or private.

The prediction model can be a machine-learning-based model that is implemented by the computer device 130. For example, the computer device 130 can use techniques such as decision trees, logistic regression, random forest, neural networks, or any other machine-learning technique to implement the prediction model. It should be noted that the type of prediction model used does not affect the aspects of the technical solutions described herein. The prediction model is trained to output a confidence score, which represents a probability, that a cluster 410 or a charging station 120 is a public charging station (or private). The prediction model is trained to output the confidence score based on the one or more characteristics and/or the geographical context that are accumulated by the computer device 130. The prediction model is pre-trained. In some embodiments, the prediction model is continuously trained as the method 200 is executed.

The method 200 includes determining, by the computer device 130, using the prediction model, a confidence score that the cluster 410 is a public charging station at block 204. The prediction model uses one or more attributes associated with the charging station 120 to determine the confidence score.

The method 200 may include in response to the confidence score being greater than a first predetermined threshold, adding, by the computer device 130, the undocumented charging station to the dataset of known charging stations as a public charging station at block 206. As described herein, the charging station is recorded as a known public charging station by recording it as part of the first list 142. At block 208, the computer device 130, in response to the confidence score being lesser than the first predetermined threshold and greater than a second predetermined threshold, adds the undocumented charging station to the third list 146 of charging stations to investigate. Further, at block 210, in response to the confidence score being lesser than the second predetermined threshold, the computer device 130 adds the undocumented charging station to the second list 144 of the known private charging stations.

The charging station dataset 140 that is maintained in this manner by the computer device 130 is used to respond to one or more requests from the user 102. In one or more embodiments, the user 102 can seek one or more charging stations, for example, along a particular route, in a particular geographical region, etc. The user 102 can seek such results via the device 104 and/or the infotainment system 112.

A technical challenge addressed by one or more embodiments described herein further includes presenting, to the user 102, one or more charging stations 120 in response to a request from the user 102. The technical challenge includes identifying a specific type of charging station that the user 102 prefers for the provided request without the user explicitly providing attributes that he/she is seeking in the charging station 120. The attributes that the user 102 seeks can vary based on his/her location, time of day, day of the week, etc. Embodiments described herein facilitate technical solutions that learn to suggest one or more charging stations 120 that have attributes tuned to one or more preferences of the user 102, where such preferences are automatically determined. For instance, embodiments herein can learn that during mornings, the user 102 prefers to stop at a fast-charging station that is located near a café. Accordingly, charging stations that meet such conditions are given more weight when suggesting charging stations to the user 102 in the mornings.

FIG. 1 depicts results 160 that are presented to the user 102. The results 160 can include a list of one or more charging stations 120 and their attributes that are presented to the user 102 in response to a request to search for charging stations. The results 160 can be presented to the user via the infotainment system 112 and/or the device 104. The results 160 are based on the charging station dataset 140 that is maintained by the computer device 130. In one or more embodiments, the results 160 are generated by the computer device 130. Alternatively, or in addition, the results 160 are generated by the computer device, the infotainment device 112, or the device 104, or a combination thereof.

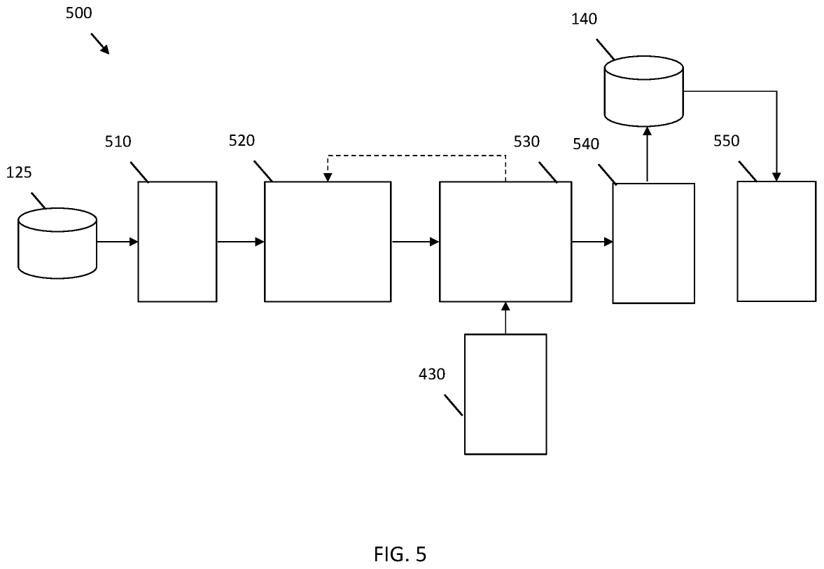

FIG. 5 depicts an operational flow of a method for detection, characterization, and presentation of charging stations for electric vehicles according to one or more embodiments. The method 500 includes, at block 510, pre-processing the charging session dataset 125. The pre-processing can include parsing, syntactic analysis, semantic analysis, and other such operations to ensure that the data in the charging session dataset 125 can be machine-analyzed. The pre-processing can also include operations such as data normalization, data reduction, data discretization, and data sampling, among other pre-processing operations. Further yet, in one or more embodiments, the pre-processing can include transforming one or more data fields in the charging session dataset 125 from one format to another.

The pre-processed data is then analyzed for performing the clustering, at block 520. The clustering can cause one or more existing clusters 410 of charging stations to be updated. Alternatively, or in addition, new clusters 410 are identified based on the charging stations in the charging session dataset 125.

At block 530, the characteristics of the clusters 410 are determined. The characteristics of a particular cluster 410 are determined from the charging session dataset 125 based on the charging sessions from multiple vehicles 110 using that cluster 410. The geographical characteristics are determined by using the application programming interface of one or more third-party service providers. In one or more embodiments, the parameters used for clustering the data are updated based on the characteristics.

At block 540, the one or more clusters 410 are analyzed by a prediction model to determine if each of the clusters 410 is a public charging station or a private charging station. The prediction model is a pre-trained machine-learning model that is trained based on one or more characteristics of known public and private charging stations. The charging station dataset 140 is updated based on the characterization of the clusters 410 that are detected from the charging session dataset 125.

The updated charging station dataset 140 is used, at block 550, for responding to any queries regarding charging stations from the user 102. In one or more embodiments, the charging station dataset 140 is used to provide results 160 for queries regarding charging stations, such as to identify charging stations along a particular route.

In one or more embodiments, responding to the user's query includes monitoring and using the user's behavior regarding charging sessions 125. For example, the charging sessions of the particular user 102 are analyzed to determine specific preferences that the user 102 exhibits when charging the vehicle 110. For example, over multiple charging sessions that the user 102 has performed for the vehicle 110, specific attributes of charging sessions and the charging stations 120 used for such charging sessions are identified. Another machine-learning model is trained to identify such user preferences in one or more embodiments.

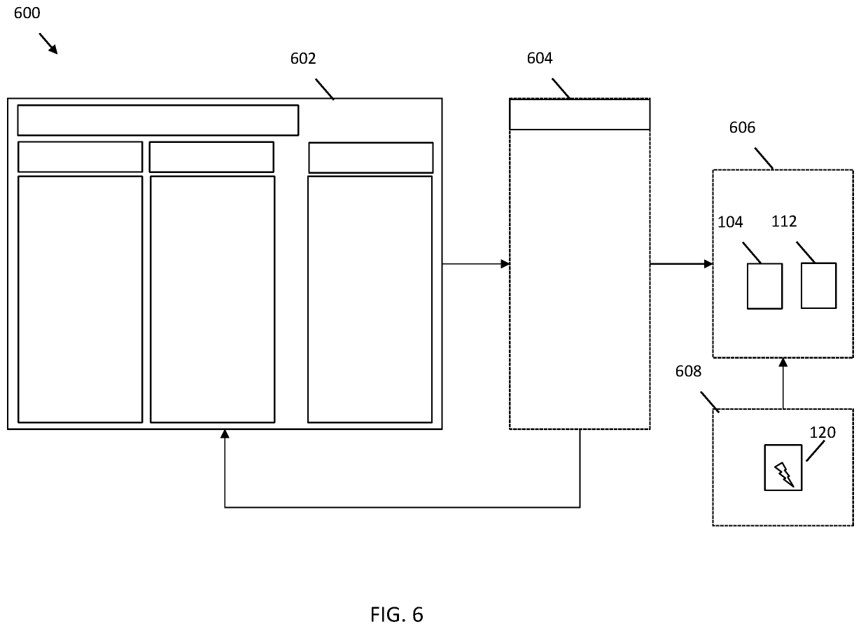

FIG. 6 depicts an operational flow depicting a method for the presentation of charging stations for electric vehicles according to one or more embodiments. The method 600 includes training the user-behavior model, which is a machine-learning model, at block 602. The user-behavior model can be based on any machine-learning technique such as neural networks, logistic regression, etc. The user-behavior model is trained by monitoring the charging session dataset 125 for the charging sessions performed specifically by the user 102. The user-behavior model is trained to identify various characteristics of the charging sessions to identify specific preferences of the user 102 when charging the vehicle 110 based on certain spatial and temporal contextual data. The spatial contextual data includes a location of the user 102 from which the user 102 selects a particular charging station 120. The temporal contextual data includes a time of the day, day of the week, etc., at which the user 102 selects a particular charging station 120. The user-behavior model is used to determine a correlation between the spatial and temporal contextual data and the characteristics of the charging station 120 (or cluster 410) that is selected by the user 102. For example, the nearby amenities within a predetermined vicinity of the charging station 120 are ranked to determine the importance of such amenities to the user 102 (e.g., nearby restroom, café, etc.)

The user's 102 preferences that the user-behavior model learns are used to identify one or more charging stations 120 from the charging stations' dataset 140, at block 604. In one or more embodiments, the charging stations 120 (or clusters 410) are identified in response to a query from the user 102. Alternatively, or in addition, the charging stations 120 are identified in response to the charge level of the vehicle 110 falling below a predetermined threshold (e.g., 20%, 15%, etc.). In other embodiments, the charging stations 120 are identified in response to a predicted drivable charge left in the vehicle 110 being below a predetermined threshold (e.g., 50 miles, 30 miles, etc.).

The results 160 of identifying such charging stations 120 are provided to the user 102 via the device 104 and/or the infotainment system 112, at block 606. In addition, at block 608, a type (public/private) of the identified charging stations 120 is also determined based on the charging stations dataset 140 and displayed to the user 102. The type of charging stations 120 is determined using the prediction model described herein.

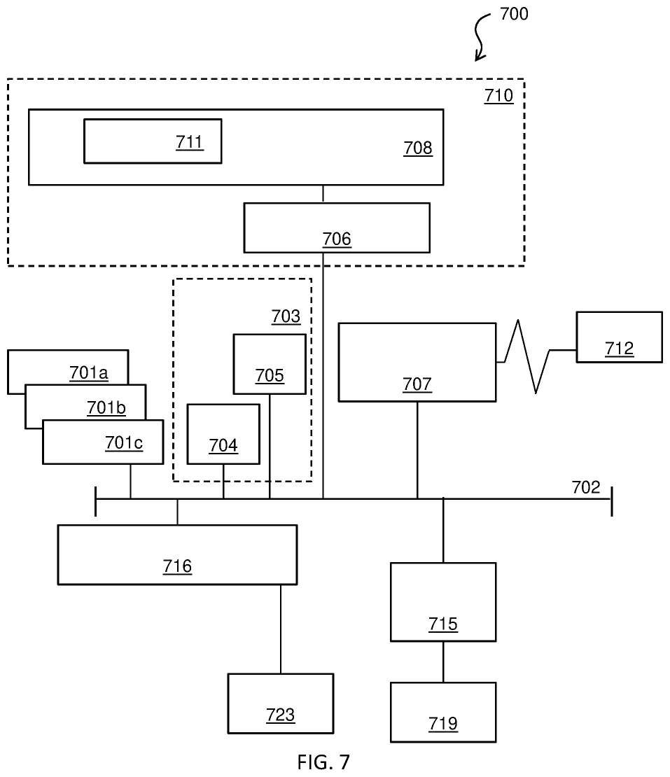

Turning now to FIG. 7, a computer system 700 is generally shown in accordance with an embodiment. The computer system 700 can be an electronic computer framework comprising and/or employing any number and combination of computing devices and networks utilizing various communication technologies, as described herein. The computer system 700 can be easily scalable, extensible, and modular, with the ability to change to different services or reconfigure some features independently of others. The computer system 700 may be, for example, a server, desktop computer, laptop computer, tablet computer, or smartphone. In some examples, computer system 700 may be a cloud computing node. Computer system 700 may be described in the general context of computer system executable instructions, such as program modules, being executed by a computer system. Generally, program modules may include routines, programs, objects, components, logic, data structures, and so on that perform particular tasks or implement particular abstract data types. Computer system 700 may be practiced in distributed cloud computing environments where tasks are performed by remote processing devices that are linked through a communications network. In a distributed cloud computing environment, program modules may be located in both local and remote computer system storage media, including memory storage devices.

As shown in FIG. 7, the computer system 700 has one or more central processing units (CPU(s)) 701a, 701b, 701c, etc. (collectively or generically referred to as processor(s) 701). The processors 701 can be a single-core processor, multi-core processor, computing cluster, or any number of other configurations. The processors 701, also referred to as processing circuits, are coupled via a system bus 702 to a system memory 703 and various other components. The system memory 703 can include a read only memory (ROM) 704 and a random access memory (RAM) 705. The ROM 704 is coupled to the system bus 702 and may include a basic input/output system (BIOS), which controls certain basic functions of the computer system 700. The RAM is read-write memory coupled to the system bus 702 for use by the processors 701. The system memory 703 provides temporary memory space for operations of said instructions during operation. The system memory 703 can include random access memory (RAM), read only memory, flash memory, or any other suitable memory systems.

The computer system 700 comprises an input/output (I/O) adapter 706 and a communications adapter 707 coupled to the system bus 702. The I/O adapter 706 may be a small computer system interface (SCSI) adapter that communicates with a hard disk 708 and/or any other similar component. The I/O adapter 706 and the hard disk 708 are collectively referred to herein as a mass storage 710.

Software 711 for execution on the computer system 700 may be stored in the mass storage 710. The mass storage 710 is an example of a tangible storage medium readable by the processors 701, where the software 711 is stored as instructions for execution by the processors 701 to cause the computer system 700 to operate, such as is described hereinbelow with respect to the various Figures. Examples of computer program product and the execution of such instruction is discussed herein in more detail. The communications adapter 707 interconnects the system bus 702 with a network 712, which may be an outside network, enabling the computer system 700 to communicate with other such systems. In one embodiment, a portion of the system memory 703 and the mass storage 710 collectively store an operating system, which may be any appropriate operating system to coordinate the functions of the various components shown in FIG. 7.

Additional input/output devices are shown as connected to the system bus 702 via a display adapter 715 and an interface adapter 716 and. In one embodiment, the adapters 706, 707, 715, and 716 may be connected to one or more I/O buses that are connected to the system bus 702 via an intermediate bus bridge (not shown). A display 719 (e.g., a screen or a display monitor) is connected to the system bus 702 by display adapter 715, which may include a graphics controller to improve the performance of graphics-intensive applications and a video controller. A keyboard, a mouse, a touchscreen, one or more buttons, a speaker, etc., can be interconnected to the system bus 702 via the interface adapter 716, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI). Thus, as configured in FIG. 7, the computer system 700 includes processing capability in the form of the processors 701, and, storage capability including the system memory 703 and the mass storage 710, input means such as the buttons, touchscreen, and output capability including the speaker 723 and the display 719.

In some embodiments, the communications adapter 707 can transmit data using any suitable interface or protocol, such as the internet small computer system interface, among others. The network 712 may be a cellular network, a radio network, a wide area network (WAN), a local area network (LAN), or the Internet, among others. An external computing device may connect to the computer system 700 through the network 712. In some examples, an external computing device may be an external web server or a cloud computing node.

It is to be understood that the block diagram of FIG. 7 is not intended to indicate that the computer system 700 is to include all of the components shown in FIG. 7. Rather, the computer system 700 can include any appropriate fewer or additional components not illustrated in FIG. 7 (e.g., additional memory components, embedded controllers, modules, additional network interfaces, etc.). Further, the embodiments described herein with respect to computer system 700 may be implemented with any appropriate logic, wherein the logic, as referred to herein, can include any suitable hardware (e.g., a processor, an embedded controller, or an application-specific integrated circuit, among others), software (e.g., an application, among others), firmware, or any suitable combination of hardware, software, and firmware, in various embodiments.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the disclosure not be limited to the particular embodiments disclosed, but will include all embodiments falling within the scope of the application.

What is claimed is:

1. A system, comprising:
a memory device; and
one or more hardware processors configured by machine-readable instructions for detection, characterization, and presentation of charging stations for electric vehicles, the one or more hardware processors configured to:
determine that a charging station used during a charging session is an undocumented charging station, wherein a documented charging station is one that is part of a dataset of known charging stations;
determine using a prediction model, a confidence score that the charging station is a public charging station, wherein the prediction model uses one or more attributes associated with the charging station to determine the confidence score;
in response to the confidence score being greater than a first predetermined threshold, add the undocumented charging station to the dataset of known charging stations as a public charging station;
in response to the confidence score being lesser than the first predetermined threshold and greater than a second predetermined threshold, add the undocumented charging station to a list of charging stations to investigate; and
in response to the confidence score being lesser than the second predetermined threshold, add the undocumented charging station to the dataset of known charging stations as a private charging station.

2. The system of claim 1, wherein the one or more hardware processors are further configured to, in response to a request from a first electric vehicle, identify one or more public charging stations in a specific geographic region using the dataset of known charging stations.

3. The system of claim 2, wherein the specific geographic region corresponds to a planned route of the first electric vehicle.

4. The system of claim 2, wherein the charging station was used by the first electric vehicle or by a second electric vehicle.

5. The system of claim 1, wherein the one or more hardware processors are further configured to train the prediction model using the one or more attributes associated with a second charging station in response to the second charging station being used during the charging session, and the second charging station being a documented charging station.

6. The system of claim 1, wherein the one or more hardware processors are further configured to:
determine that the charging station used during the charging session is on the list of charging stations to investigate; and
in response, determine, using the prediction model, the confidence score that the charging station is a public charging station using a different set of attributes associated with the charging station.

7. The system of claim 1, wherein the one or more hardware processors are further configured to associate the charging station as part of a cluster of charging stations using a clustering algorithm, wherein the clustering is performed based on geographic attributes of the charging station.

8. A non-transient computer-readable storage medium comprising instructions being executable by one or more processors to perform a method for detection, characterization, and presentation of charging stations for electric vehicles, the method comprising:
determining, by the one or more processors, that a charging station used during a charging session is an undocumented charging station, wherein a documented charging station is one that is part of a dataset of known charging stations;
determining, by the one or more processors, using a prediction model, a confidence score that the charging station is a public charging station, wherein the prediction model uses one or more attributes associated with the charging station to determine the confidence score;
in response to the confidence score being greater than a first predetermined threshold, adding, by the one or more processors, the undocumented charging station to the dataset of known charging stations as a public charging station;
in response to the confidence score being lesser than the first predetermined threshold and greater than a second predetermined threshold, adding, by the one or more processors, the undocumented charging station to a list of charging stations to investigate; and
in response to the confidence score being lesser than the second predetermined threshold, adding, by the one or more processors, the undocumented charging station to the dataset of known charging stations as a private charging station.

9. The computer-readable storage medium of claim 8, wherein the method further comprises, in response to a request from a first electric vehicle, identifying, by the one or more processors, one or more public charging stations in a specific geographic region using the dataset of known charging stations.

10. The computer-readable storage medium of claim 9, wherein the specific geographic region corresponds to a planned route of the first electric vehicle.

11. The computer-readable storage medium of claim 9, wherein the charging station was used by the first electric vehicle or by a second electric vehicle.

12. The computer-readable storage medium of claim 8, wherein the method further comprises, training, the prediction model using the one or more attributes associated with a second charging station in response to the second charging station being used during the charging session, and the second charging station being a documented charging station.

13. The computer-readable storage medium of claim 8, wherein the method further comprises:
determining, by the one or more processors, that the charging station used during the charging session is on the list of charging stations to investigate; and
in response, determining, by the one or more processors, using the prediction model, the confidence score that the charging station is a public charging station using a different set of attributes associated with the charging station.

14. The computer-readable storage medium of claim 8, wherein the method further comprises, associating, by the one or more processors, the charging station as part of a cluster of charging stations using a clustering algorithm, wherein the clustering is performed based on geographic attributes of the charging station.

15. A computer-implemented method for detection, characterization, and presentation of charging stations for electric vehicles, the computer-implemented method comprising:
determining, by a processor, that a charging station used during a charging session is an undocumented charging station, wherein a documented charging station is one that is part of a dataset of known charging stations;
determining, by the processor, using a prediction model, a confidence score that the charging station is a public charging station, wherein the prediction model uses one or more attributes associated with the charging station to determine the confidence score;
in response to the confidence score being greater than a first predetermined threshold, adding, by the processor, the undocumented charging station to the dataset of known charging stations as a public charging station;
in response to the confidence score being lesser than the first predetermined threshold and greater than a second predetermined threshold, adding, by the processor, the undocumented charging station to a list of charging stations to investigate; and
in response to the confidence score being lesser than the second predetermined threshold, adding, by the processor, the undocumented charging station to the dataset of known charging stations as a private charging station.

16. The computer-implemented method of claim 15, further comprising, in response to a request from a first electric vehicle, identifying, by the processor, one or more public charging stations in a specific geographic region using the dataset of known charging stations.

17. The computer-implemented method of claim 16, wherein the specific geographic region corresponds to a planned route of the first electric vehicle.

18. The computer-implemented method of claim 16, wherein the charging station was used by the first electric vehicle or by a second electric vehicle.

19. The computer-implemented method of claim 15, further comprising, training, by the processor, the prediction model using the one or more attributes associated with a second charging station in response to the second charging station being used during the charging session, and the second charging station being a documented charging station.

20. The computer-implemented method of claim 15, further comprising:
determining, by the processor, that the charging station used during the charging session is on the list of charging stations to investigate; and
in response, determining, by the processor, using the prediction model, the confidence score that the charging station is a public charging station using a different set of attributes associated with the charging station.
